(19) United States
(12) Patent Application Publication
(10) Pub. No.: US 2011/0086941 A1
(43) Pub. Date: Apr. 14, 2011

(54) METHOD OF IMPROVING CHARACTERISTICS OF A SET CEMENT IN AN OIL-AND GAS-WELL

(76) Inventors: Emmanuel Therond, Paris (FR); Cecilia Nguyen, Houston, TX (US)

(21) Appl. No.: 12/576,569

(22) Filed: Oct. 9, 2009

(51) Int. Cl. C09K 8/00

(52) U.S. Cl. 523/130

(57) ABSTRACT

The invention concerns a method of improving characteristics of a set cement in an oil- or gas-well. The method according to the invention comprises adding para-aramid synthetic fibers to a cement slurry; and allowing the cement slurry comprising the para-aramid fibers to set. The characteristic to be improved is the resistance to impact, the resistance to high temperature and pressure variations, and/or the drillability of said set cement uses of para-aramid synthetic fibers to enhance specific mechanical properties of cements in an oil- or gas-well.

### FIELD OF THE INVENTION

The invention relates to a method of improving characteristics of a set cement in an oil- and/or gas-well.

### BACKGROUND OF THE INVENTION

The statements in this section merely provide background information related to the present disclosure and may not constitute prior art.

Among cement mechanical properties, set cement exhibits good compressive strength properties compared to tensile strength properties. As a rule of thumb, the tensile strength is only one tenth of the compressive strength for most oil- and gas-well cements.

Set cement also generally exhibits low resistance to impact and is brittle. Good resistance to impact is a property especially required when cement is used to cement the junction of a multilateral well.

In some instances, when kick-off plugs are set across hard formations, reduced drillability is required for cements. This property, which is related to the rate of penetration when drilling out the cement, is difficult to quantify, although a rate of penetration device has been used to optimize cement formulations and to help determining the rate of penetration through cement plugs.

Various solutions have been proposed to improve cement properties. For example, some additives are known to one skilled in the art for their ability to modify some cement properties. Among them, strength modifying additives (SMAs), modulus-modifying additives (MMAs) and Poisson's ratio modifying additives (PRMAs) are disclosed in WO2007031736, incorporated herein after by reference thereto. In this application, various plastic fibers, including polypropylene, polyethylene, polyethylene terephtalate, polyvinyl alcohol and aramid fibers, are mentioned as SMAs, and are said to enhance the tensile strength in cement systems while reducing plastic shrinkage cracking.

Steel micro-ribbons have been used to increase cement toughness in DuraSTONE™ cement systems. Steel micro-ribbons are known to have a high specific gravity and large area, which can make them difficult to suspend when the cement slurry rheology is not properly designed.

### SUMMARY OF THE INVENTION

It is an object to provide alternative or better solutions in order to improve characteristics of cements in the field of oil- and gas-well cementing. More especially, it is an object of the present invention to increase the toughness of cement, the resistance of cement to impact, the resistance of cement sheath, especially to high temperature and pressure variations, to reduce the cement drillability, i.e. the rate of penetration, of cement and/or to help the suspension of steel micro-ribbons into cement.

Accordingly, para-aramid synthetic fibers are added to a cement slurry.

More particularly, according to a first aspect, methods of improving characteristics of a set cement in an oil- or gas-well include:

adding para-aramid synthetic fibers to a cement slurry; and
allowing the cement slurry including the para-aramid fibers to set;
and wherein the characteristic to be improved is the resistance to impact, the resistance to high temperature and pressure variations, and/or the drillability of the set cement.

According to some embodiments, the para-aramid synthetic fibers are Kevlar™ fibers; the Kevlar™ fibers are staple Kevlar™ fibers, the average length of the para-aramid synthetic fibers is comprised between 0.01 and 3.00 cm, more preferentially between 1.00 and 2.00 cm, for example approximately 1.27 cm; the cement slurry is prepared by adding a dry cement blend into water and additives; the cement is a flexible cement, for example a FlexSTONE™ from Schlumberger or a high solid fraction cement, for example DensCRETE™ cement from Schlumberger™; the para-aramid synthetic fibers are added, in the cement slurry, in an amount comprised between 1.43 kg/m³ (0.50 lb/bbl) and 14.27 kg/m³ (5.0 lb/bbl), preferentially between 4.28 kg/m³ (1.50 lb/bbl) and 7.14 kg/m³ (2.50 lb/bbl); the cement slurry comprises steel micro-ribbons, and the para-aramid synthetic fibers enhance the suspension of said steel micro-ribbons into said cement slurry; the set cement is provided in a kick-off plug of an oil- or gas-well; and the set cement is provided in a junction of a multilateral oil- or gas-well.

### BRIEF DESCRIPTION OF THE DRAWINGS

Other features and aspects of the present invention will be apparent from the following description and the accompanying drawings, in 3 which:

FIG. 1 is a scheme of the breakage pattern of the core of a cement cylindrical sample when exposed to the Brazilian tensile strength test;

FIG. 2 is a graph showing the evolution of the tensile stress over time for a 12.7 ppg (1.52 g/cm³) FlexSTONE™ cement system, with or without Kevlar™ fibers;

FIG. 3 is a graph showing the evolution of the tensile stress over time for a 16.4 ppg (1.97 g/cm³) Class H cement system, with or without Kevlar™ fibers; and

FIG. 4 is a graph showing the evolution of the tensile stress over time for a 17.5 ppg (2.09 g/cm³) DensCRETE™ cement system, with or without Kevlar™ fibers.

### DETAILED DESCRIPTION OF THE PREFERRED EMBODIEMENTS

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure.

The addition of para-aramid synthetic fibers to a base cement system does not only increase the compressive strength and the tensile strength of cements but also improves other mechanical properties of cements and, in particular, their toughness, their resistance to impact, the resistance of cement sheath, especially to high temperature and pressure variations. It also reduces the drillability of set cements.

Moreover, the addition of para-aramid synthetic fibers to a base cement system decreases the required concentration in other additives into cement systems, especially steel-ribbons into systems such as DuraSTONE™ and improves the suspension of those steel-ribbons.

Thus, several mechanical properties of oil- and gas-well cements are improved by adding para-aramid synthetic fibers, to cements. On the contrary, the international application published under the number WO2007031736 discloses additives with an effect on one particular property of cement at a time, and the para-aramid fibers are not mentioned as enhancer of cement toughness, of cement resistance to impact, of steel-ribbons suspending properties and/or as reducer of cement drillability (rate of penetration). Moreover, para-aramid synthetic fibers have not been used in oil- or gas-well cement formulations, and the international application published under the number WO2007031736 does not provide any evidence of the beneficial effect of the plastic fibers on cement properties.

A base cement system according to the invention may comprise any cement system known in the art, especially pumpable cement systems such as the ones used for oil- and gas-well cementing. For example, the base cement system may be chosen from or comprise a conventional cement system, such as Portland® cements from Lehigh™ or any other supplier, especially class H cement or any other class and type of cement from Lehigh™ or any other supplier or a more advanced cement system, such as CemCRETE™, CemSTONE™, DeepCEM™, DeepCRETE™, UniSLURRY™, FlexSTONE™ or DensCRETE™ cement systems from Schlumberger™ competitive cement system are also encompassed by the present application. The preferred base cement systems are Portland cement, DuraSTONE™, flexible cement such as FlexSTONE™ and high solid fraction cement such as DensCRETE™ cements from Schlumberger™. Their compositions are provided in Table 1a and in example 6 for DuraSTONE™.

The para-aramid synthetic fibers according to the invention are more preferably poly-paraphenylene terephthalamide fibers, also known as Kevlar™ fibers from DuPont™. More preferably, the fibers are staple fibers. Their average length is comprised between 0.01 and 3.00 cm, preferably between 1.00 and 2.00 cm. More preferably, the average length of the para-aramid synthetic fibers is of approximately 1.27 cm (½″). On one side, if the fibers are too long, then mixing said fibers in the cement slurry is difficult; on the other side, and improvement of the mechanical properties may not be observed, if the fibers are too short in length.

Hence, the para-aramid synthetic fibers are added into a cement slurry mixture, i.e. a base cement blend system mixed with a suitable aquesous fluid such as fresh water, sea water or brines. The concentration of the fibers is adjusted to its maximum while allowing a good mixability of the cement slurry mixture. The fibers density in the cement slurry mixture is preferably comprised between 2 and 6 kg/m³, preferably between 5 and 6 kg/m3, preferably between 5.5 and 5.8 kg/m³, preferably of 5.7 kg/m³ (i.e. 1.5 pound/barrel).

The fibers-containing cement slurry mixture is mixed.

When solid cement is to be obtained, the cement slurry system sets according to the cement provider's instructions.

The cements of the invention are suitable for gas and/or oil wellbore cementing, especially in deep water wellbore cementing. They are also useful in zonal isolation, in order to prevent liquids or gases from flowing from one zone to another within the wellbore. The cements of the invention are particularly useful in kick off plugs or in multilateral junctions.

The following descritpion is directed to particular embodiments of the invention and to demonstrate the practice and advantages thereof. It is understood that the embodiments are given by way of illustration and are not intended to limit the scope of the invention.

Various tests have been performed for different cement slurry systems with and without Kevlar™ staple fibers, ½″ long, i.e. 1.27 cm long, from Dupont™ to determine the effectiveness of the fibers. These different cement slurry systems are described in the example 1 and the tests are described in the examples 2 to 6.

### Example 1

### Composition and Preparation of Cement Slurry According to the Invention

The cement slurry systems comprise a base cement and water. The base cements flexible cement, Conventional, i.e. Class H (LeHigh™) or high solid fraction cement, as defined in Table 1, are mixed with water according to the API RP 10B-2, Recommended Practice for Testing Well Cements, 1st edition. The proportions of cement blend and of water, before the addition of Kevlar™ fibers (TBC), are indicated by the density values reported in Table 1a. The proportions of each component of the cement are reported in the column “Composition” in Table 1a, in percentage by volume of blend (BVOB) of the cement slurry system, i.e. after the addition of water and before the addition of Kevlar™ fibers.

Methods of incorporating fibers into cement composition are known to one skilled in the art. More preferably, to obtain cement samples with fibers according to the invention, staple Kevlar™ fibers (½″ long, i.e. 1.27 cm long) from Dupont™ are added to the cement slurry mixture. As reported in Table 1 b, a Kevlar™ fibers concentration of 4.28 kg/m³ (i.e. 1.5 lb/bbl) is a concentration allowing a good mixability of the cement slurry system.

TABLE 1a
Composition of cement slurry systems

| Base cement | Cement | Composition of the cement slurry | |
|---|---|---|---|
| blend used in | slurry | systems (percentage of weight out | |
| the cement | system | of the total weight of the cement | SVF |
| slurry system | density | slurry system) | (%) |
| Flexible | 1.52179 | 10 to 50% BVOB Class H | 55 |
| cement | g/cm3 | (LeHigh ™), 0 to 50% BVOB | |
| | (12.7 | crystalline silica, 20 to 70% BVOB | |
| | ppg) | elastomeric material | |
| | | 10 to 50% BVOB Class H | |
| | | (LeHigh ™), 0 to 50% BVOB | |
| | | crystalline silica, 20 to 70% BVOB | |
| | | elastomeric material, Kevlar ™ | |
| | | Fibers (5.8 kg/m3) | |
| Conventional | 1.9651 | Class H (LeHigh ™) | 44.8 |
| | g/cm3 | Class H (LeHigh ™), Kevlar ™ Fibers | |
| | (16.4 | (5.8 kg/m3) | |
| | ppg) | | |
| High solid | 2.0969 | 10 to 50% BVOB Class H | 60.0 |
| fraction cement | g/cm3 | (LeHigh ™), 0 to 50% BVOB of a fine | |
| | (17.5 | crystalline silica, 10 to 70% BVOB of | |
| | ppg) | a coarse crystalline silica | |
| | | 0 to 50% BVOB Class H (LeHigh ™), | |
| | | 0 to 50% BVOB of a fine crystalline | |
| | | silica, 10 to 70% BVOB of a coarse | |
| | | crystalline silica, Kevlar ™ Fibers | |
| | | (5.8 kg/m3) | |

where “SVF” means “Solid Volume Fraction”.

TABLE 1b
Maximum concentration of Kevlar ™ fibers
for different cement slurry systems

| Base cement | | Concentration of |
|---|---|---|
| blend used in the | Density of cement | Kevlar ™ fibers into |
| cement slurry | slurry system before | the cement slurry |
| system | the addition of fibers | system |
| Flexible | 1.522 g/cm3 (12.7 | 4.28 kg/m3 (1.5 |
| cement | ppg) | lb/bbl) |
| Conventional | 1.965 g/cm3 (16.4 | 4.28 kg/m3 (1.5 |
| | ppg) | lb/bbl) |
| High solid | 2.097 g/cm3 (17.5 | 4.28 kg/m3 (1.5 |
| fraction cement | ppg) | lb/bbl) |

### Example 2

### Destructive Compressive Strength Test

For each cement slurry system as defined in example 1, the cement slurry is poured into a 5.1 cm×5.1 cm×5.1 cm (2×2×2 inches) cubic mold and the slurry is stirred using a glass rod to remove trapped air. The cement cube is cured in a water bath at 26.67° C. (80° F.) for 48 hours. The solid cement cube is then removed from the mold. The samples are crushed on the hydraulic press and the compressive strength is measured according to API RP10B-2. The pressure for which a first crack is observed on the cement sample is measured and is reported in Table 2.

TABLE 2
Destructive compressive strength results

| Base cement | Compressive strength of | Compressive strength of |
|---|---|---|
| blend used in | the solid cement cube | the solid cement cube |
| the cement | made with cement slurry | made with cement slurry |
| slurry system | system without fibers | system with Kevlar ™ fibers |
| Flexible | 2.57 MPa (373 psi) | 4.25 MPa (617 psi) |
| cement | | |
| Conventional | 24.52 MPa (3559 psi) | 29.27 MPa (4248 psi) |
| High solid | 14.36 MPa (2084 psi) | 21.09 MPa (3061 psi) |
| fraction cement | | |

During the destructive compressive strength test, the cement systems with Kevlar™ fibers allowed the cube structure to stay intact. The results reported in Table 2 show that the Kevlar™ fibers increase the compressive strength of the cement systems.

### Example 3

### Brazilian Tensile Strength Test

Brazilian tensile strength procedure was followed, that is:

Cut a cylinder core plug with 1.5 inch (0.035 m) in diameter and 1 inch (0.025 m) in length.

Lying the sample on its side on the test equipment.

Increase pressure until sample failed as indicated below.

The test was done for each cement slurry as defined in example 1, the cement slurry is mixed with and without Kevlar™ fibers. The cement slurry mixture is poured into a 60 ml syringe cylinder (3.8 cm (1.5 inch) diameter core plug), trapped air is removed, and the cement is cured in a water bath at 26.67° C. (80° F.) for 48 hours. The core plug is then removed from the cylinder and is cut into 2.5 cm (1 inch) in length.

As shown in FIG. 1, a cut-up core plug of cement is placed on its side and on a hydraulic load frame equipped with a load cell (such as Tinius-Olsen press). A force is then applied and is increased until a failure appears on the cement sample. The maximum failure load, i.e. the applied force for which a first failure is observed on the cement sample, is recorded and reported in Table 3.

TABLE 3
Brazilian tensile strength results

| Base cement | Tensile strength of the | Tensile strength of the |
|---|---|---|
| blend used in | solid cement cube made | solid cement cube made |
| the cement | with cement slurry system | with cement slurry system |
| slurry system | without fibers | with Kevlar ™ fibers |
| Flexible | 0.33 MPa (48 psi) | 0.59 MPa (85 psi) |
| cement | | |
| Conventional | 1.50 MPa (218 psi) | 2.21 MPa (321 psi) |
| High solid | 1.04 MPa (151 psi) | 2.02 MPa (293 psi) |
| fraction cement | | |

The results in Table 3 show that the Kevlar™ fibers are very effective in increasing the tensile strength of the cement systems.

The Brazilian tensile strength is calculated from the equation below:

$${σ}_{T} = \frac{2 * F}{π * L * D}$$

wherein:
σ_{T}=Brazilian Tensile Strength (psi, i.e. pound per square inch)
D=Diameter of the core sample (inch)
F=Maximum Failure Load (pound)
L=Length of the core sample (inch)

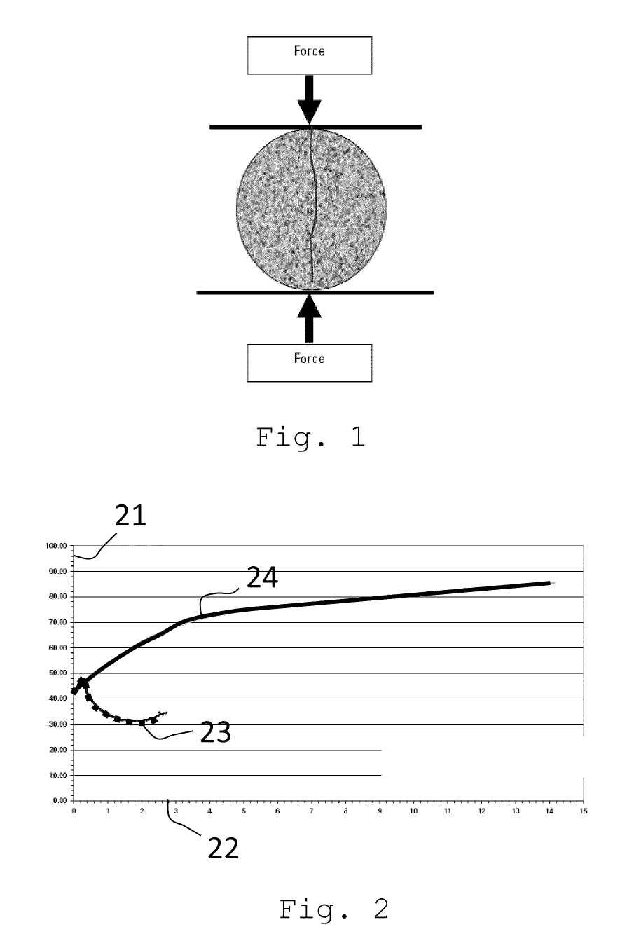

The Brazilian tensile strength test was performed at various times upon the cement solidification, the cement samples being prepared as previously described in example 3. The results are reported on the graphs in FIGS. 2 to 4.

In FIG. 2, the Y axis 21 represents the levels of tensile stress in psi (1 psi equals 6,894.76 Pa) and the X axis 22 represents the time in minutes (min). The curve 23 shows the tensile stress over time for FlexSTONE™ system without fibers, whereas the curve 24 shows the tensile stress over time for FlexSTONE™ system with Kevlar™ fibers.

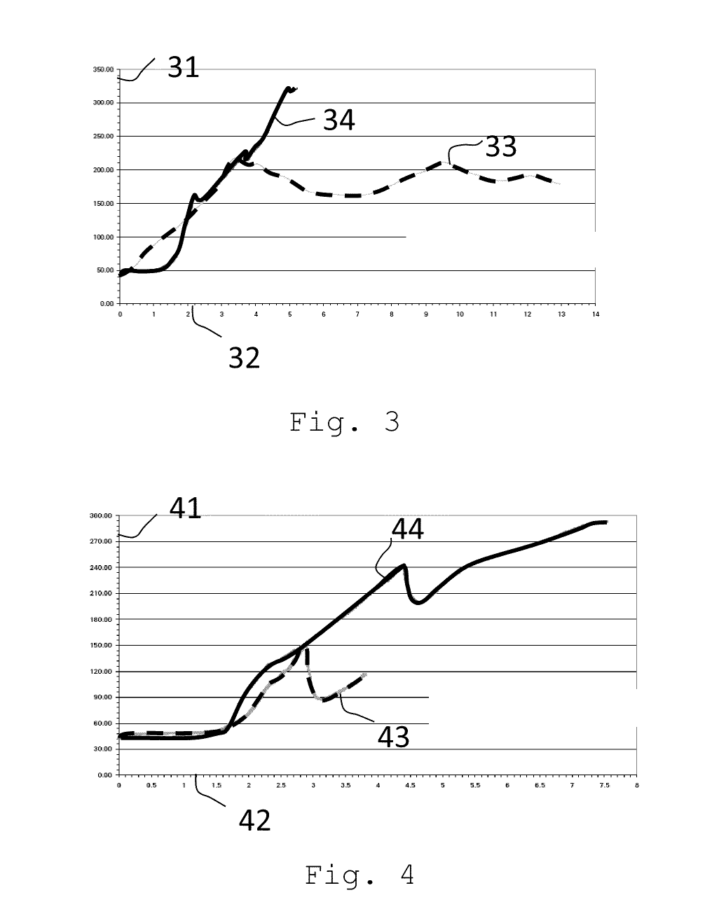

In FIG. 3, the Y axis 31 represents the levels of tensile stress in psi and the X axis 32 represents the time in minutes (min). The curve 33 shows the tensile stress over time for Conventional cement system without fibers, whereas the curve 34 shows the tensile stress over time for Conventional cement system with Kevlar™ fibers.

In FIG. 4, the Y axis 41 represents the levels of tensile stress in psi and the X axis 42 represents the time in minutes (min). The curve 43 shows the tensile stress over time for DensCRETE™ cement system without fibers, whereas the curve 44 shows the tensile stress over time for DensCRETE™ cement system with Kevlar™ fibers.

The results in FIGS. 2 to 4 show that the Kevlar™ fibers are very effective in increasing the tensile strength of the cement systems over time.

### Example 4

### Cement Sheath Temperature Increase Test

To test the effect of temperature increase on the cement sheath with and without Kevlar fibers, for each cement slurry as defined in example 1, the cement slurry is mixed with and without Kevlar™ fibers. The cement slurry mixture is poured into an annular mold simulating a cemented annulus and is cured at 65.56° C. (150 F) for 48 hours. The outside steel pipe is removed and the solid cement annular sample around the inside steel pipe is then exposed to an increasing temperature and the temperature at which an initial crack is recorded, as well as the temperature at which a complete crack of the sample is observed. The results are reported in Table 4.

TABLE 4
Effect of Temperature Stress on Cement Sheath

| | Temperature | | |
|---|---|---|---|
| Cement slurry | | Complete crack | |
| system | Initial Crack | (top to bottom) | Observation |
| Flexible cement | 82.22° C. (180° F.) | 93.33° C. (200° F.) | Several cracks all |
| | | | around the sample |
| Flexible cement | 90.56° C. (195° F.) | 98.89° C. (210° F.) | Single thin crack |
| with Kevlar ™ | | | |
| fibers | | | |
| Conventional | 68.33° C. (155° F.) | 71.11° C. (160° F.) | Several cracks all |
| | | | around the sample |
| Conventional with | 75.56° C. (168° F.) | 93.33° C. (200° F.) | Single thin crack |
| Kevlar ™ fibers | | | |
| High solid fraction | 80.56° C. (177° F.) | 82.22° C. (180° F.) | Several cracks all |
| cement | | | around the sample |
| High solid fraction | 85° C. (185° F.) | 93.33° C. (200° F.) | Single thin crack |
| cement with | | | |
| Kevlar ™ fibers | | | |

The results reported in Table 4 show that the Kevlar™ fibers help the cement sheath to sustain stress from high temperature increase. It is also observed that the Kevlar™ fibers provide the cement systems to remain intact after the initial crack and complete crack of the cement sheath. Moreover, the sheath of cement systems with fibers had less cracks than the sheath of cement systems without fibers.

### Example 5

### Impact Resistance Test

The impact resistance test determines the amount of blows of a steel bar with pulley that is required to break a solid cement sample, the steel bar being dropped from a standardized height onto said cement sample. For the impact resistance test, the preparation of the cement sample is similar to the destructive compressive strength test: for each cement slurry of example 1, the cement slurry mixture is poured into a 5.1 cm×5.1 cm×5.1 cm (2×2×2 inches) cubic mold and the slurry is stirred using with a glass rod to remove trapped air. The cement cube is then cured in a water bath at 65.56° C. (150 F) for 72 hours. Each kind of cement cube is made in triplicate. An instrumental drop weight tower (impact apparatus) is used to determine the amount of blows required to observe an initial crack and to observe a complete crack of the cement sample. The results are reported in Table 5. Each impact delivers an energy of 50 N.m

TABLE 5
Impact of Steel Bar on Cement Systems

| | Number of blows of steel bar on cement systems | | | | | | |
|---|---|---|---|---|---|---|---|
| | | | | Complete crack | | | |
| Cement slurry | | | | (sample cracked | | | |
| system | Initial Crack | | | from top to bottom) | | | Observation |
| Flexible cement | 1 | 1 | 1 | 1 | 1 | 1 | Sample shattered |
| Flexible cement | 1 | 1 | 1 | 2 | 2 | 2 | Sample stays |
| with fibers | | | | | | | together |
| Conventional | 1 | 1 | 1 | 2 | 1 | 2 | Sample shattered |
| Conventional with | 3 | 4 | 3 | 5 | 5 | 4 | Sample stays |
| fibers | | | | | | | together |
| High solid fraction | 1 | 1 | 1 | 1 | 1 | 1 | Sample shattered |
| cement | | | | | | | |
| High solid fraction | 1 | 1 | 1 | 2 | 2 | 2 | Sample stays |
| cement with fibers | | | | | | | together |

According to the results in Table 5, the cement systems with Kevlar™ fibers sustain a better impact from the steel bar compared to the systems without Kevlar™ fibers. Moreover, the fibers help the cement systems to remain intact after the cement cubes are completely shattered.

### Example 6

### Para-Aramid Synthetic Fibers in DuraSTONE™ Cement System

DuraSTONE™ cement system contains steel micro-ribbons in order to increase the toughness of the cement. Steel micro-ribbons have a high specific gravity and large area, which makes them difficult to suspend in the cement slurry. Surprisingly, the addition of para-aramid synthetic fibers, especially Kevlar™, into DuraSTONE™ cement system helps suspending the steel micro-ribbons, decreases the required concentration of ribbons and further improves the mechanical properties of DureSTONE™ into cement systems. The characteristics of Kevlar™ fibers compared to steel-ribbons are given in Table 6 hereunder.

| | Para-aramid fibers | Steel micro-ribbons |
|---|---|---|
| Specific Gravity | 1.44 | 7.20 |
| Tensile strength | 2.96 × 10⁹ Pa (430,000 | 0.48 × 10⁹ Pa (70,000 psi) |
| | psi) | |
| Typical | 4.28 kg/m3 (1.5 lb/bbl; | 99.86 kg/m3 (35 lb/bbl; |
| concentration | 0.12 gal/bbl) | 0.58 gal/bbl) |

### Remarks

The results of the previous tests show that the addition of ½″ long staple Kevlar™ fibers into a cement system at a concentration of 4.28 kg/m3 (i.e. 1.5 lb/bbl) has the following beneficial effects:

1) the compressive strength is increased by 20% for the Class H cement system, by 47% for the high solid fraction cement such as DensCRETE™ cement system and 65% for the flexible cement such as FlexSTONE™ cement system;
2) the tensile strength is increased by 60% for the Class H cement system, by 76% for the high solid fraction cement such as DensCRETE™ cement system and doubled for the flexible cement such as FlexSTONE™ cement system;
3) the cemented annulus is more resistant to casing expansion with temperature increase for the Class H cement system, for the high solid fraction cement such as DensCRETE™ cement system and for the flexible cement FlexSTONE™ cement system;
4) the cement systems present an increased resistance to impact;
5) the cement systems present an increased toughness, as the samples with fibers stay together when broken, whereas the samples without fibers shatter when broken;
6) steel micro-ribbons are easier to suspend into the DuraSTONE™ cement system, and they can be used in smaller concentration while the DuraSTONE™ cement system presents improved mechanical properties; and
7) the addition of the addition of ½″ long staple Kevlar™ fibers into a cement system also allows a reduction of the cement drillability.

While preferred embodiments of the invention have been shown and described, modifications thereof can be made by one skilled in the art without departing from the spirit and teachings of the invention. Accordingly, the scope of protection is not limited by the description set out above but includes all equivalents of the subject matter of the claims.

We claim:

1. A method of improving characteristics of a set cement in an oil- or gas-well, the method comprising:
adding para-aramid synthetic fibers to a cement slurry; and
allowing the cement slurry comprising the para-aramid fibers to set;
and wherein the improved characteristic is one or more of resistance to impact, resistance to high temperature, resistance to pressure variations, or drillability of said set cement.

2. The method of claim 1, wherein the para-aramid synthetic fibers are Kevlar™ fibers.

3. The method of claim 2, wherein the Kevlar™ fibers are staple Kevlar™ fibers.

4. The method of claim 1, wherein the average length of the para-aramid synthetic fibers is from about 0.01 to about 3.00 cm.

5. The method of claim 4, wherein the average length of the para-aramid synthetic fibers is from about 1.00 to about 2.00 cm.

6. The method of claim 5, wherein the average length of the para-aramid synthetic fibers is approximately 1.27 cm.

7. The method of claim 1, wherein the cement slurry is prepared by adding water to a cement system in the form of a powder.

8. The method of claim 7, wherein the cement system is a flexible cement or high solid fraction cement system.

9. The method of claim 1, wherein the para-aramid synthetic fibers are added, in the cement slurry, in an amount from about 1.43 kg/m³ to about 14.27 kg/m³.

10. The method claim 9, wherein the para-aramid synthetic fibers are added, in the cement slurry, in an amount from about 4.28 kg/m³ to about 7.14 kg/m³.

11. The method of claim 1, wherein the cement slurry comprises steel micro-ribbons, and wherein the para-aramid synthetic fibers enhance the suspension of said steel micro-ribbons into said cement slurry.

12. The method of claim 1, wherein the set cement is provided in a kick-off plug of an oil- or gas-well.

13. The method of claim 1, wherein the set cement is provided in a junction in a multilateral oil- or gas-well.

14. A method comprising:
providing a cement slurry;
adding para-aramid synthetic fibers to the cement slurry; and
allowing the cement slurry comprising the para-aramid fibers to set;
wherein one or more of resistance to impact, resistance to high temperature, resistance to pressure variations, or drillability of the set cement are improved.

15. The method of claim 14, wherein the para-aramid synthetic fibers are Kevlar™ fibers.

16. The method of claim 14, wherein the average length of the para-aramid synthetic fibers is from about 0.01 to about 3.00 cm.

17. The method of claim 14, wherein the cement slurry comprises steel micro-ribbons, and wherein the para-aramid synthetic fibers enhance the suspension of said steel micro-ribbons into said cement slurry.

18. The method of claim 14, wherein the set cement is provided in a kick-off plug of an oil- or gas-well, or a junction in a multilateral oil- or gas-well.

19. A method of placing a cement structure in a wellbore, the method comprising:
providing a cement slurry;
adding para-aramid synthetic fibers to the cement slurry; and
allowing the cement slurry comprising the para-aramid fibers to set.

20. The method of claim 19, wherein one or more of resistance to impact, resistance to high temperature, resistance to pressure variations, or drillability of the cement structure are improved.
